(19) United States
(12) Patent Application Publication
(10) Pub. No.: US 2005/0058322 A1
(43) Pub. Date: Mar. 17, 2005

(54) System or method for identifying a region-of-interest in an image

(76) Inventors: Michael E. Farmer, West Bloomfield, MI (US); Li Wen, Rochester, MI (US); Xunchang Chen, Ann Arbor, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/663,521

(22) Filed: Sep. 16, 2003

(51) Int. Cl. G06K 9/00; G06K 9/34

(52) U.S. Cl. 382/103; 382/173; 382/181

(57) ABSTRACT

The disclosed segmentation method and system (collectively “system”) identifies a region-of-interest within an ambient image captured by a sensor. The ambient image includes the target image (the “segmented image” of the target), as well as the area surrounding the target. The disclosed system purposely “under-segments” the ambient image, and the process is typically followed by a subsequent segmentation process to remove the portions of the region-of-interest image that do not represent the segmented image. The system compares the ambient image captured by the sensor with a template ambient image without a target to assist in identifying the region-of-interest. They system performs a watershed heuristic to further remove portions of the ambient image from the region-of-interest. In a safety restraint embodiment of the system, the region-of-interest can be used by the safety restrain application to determine the classification of the vehicle occupant, and motion characteristics relating to the occupant.

### BACKGROUND OF THE INVENTION

The present invention relates in general to a system or method (collectively “segmentation system” or simply the “system”) for segmenting images. More specifically, the present invention relates to a system for identifying a region-of-interest within an ambient image, an image that includes a target image (“segmented image”) as well as the area surrounding the target image.

Computer hardware and software are increasingly being applied to new types of automated applications. Programmable logic devices (“PLDs”) and other forms of embedded computers are increasingly being used to automate a wide range of different processes. Many of those processes involve the capture of sensor images or other forms of sensor information that are then converted into some type of image. Many different automated systems are configured to utilize the information embodied in captured or derived images to invoke some type of automated response. For example, a safety restraint application in an automobile may utilize information obtained about the position, velocity, and acceleration of the passenger to determine whether the passenger would be too close to the airbag at the time of deployment for the airbag to safely deploy. A safety restraint application may also use the segmented image of an occupant to determine the classification of the occupant, selectively disabling the deployment of the airbag when the occupant is not an adult human being.

Other categories of automated image-based processing can include but are not limited to: navigation applications that need to identify other vehicles and road hazards; and security applications requiring the ability to distinguish between human intruders and other type of living beings and non-living objects. Region-of-interest processing can also be useful in image processing that does not invoke automated processing, such as a medical application that detects and identifies a tumor within an image of a human body.

Imaging technology is increasingly adept at capturing clear and detailed images. Imaging technology can be used to capture images that cannot be seen by human beings, such as still frames and video images captured using non-visible light. Imaging technology can also be applied to sensors that are not “visual” in nature, such as an ultrasound image. In stark contrast to imaging technology, advances in segmentation technology are more sporadic and context specific. Segmentation technology is not keeping up with the advances in imaging technology or computer technology. Moreover, current segmentation technology is not nearly as versatile and accurate as the human mind. In contrast to automated applications, the human mind is remarkably adept at differentiating between different objects in a particular image. For example, a human observer can easily distinguish between a person inside a car and the interior of a car, or between a plane flying through a cloud and the cloud itself. The human mind can perform image segmentation correctly even in instances where the quality of the image being processed is blurry or otherwise imperfect. The performance of segmentation technology is not nearly as robust, and the lack of robust performance impedes the use of the next generation of automated technologies.

With respect to many different applications, segmentation technology is the weak link in an automated process that begins with the capture of sensor information such as an image, and ends with an automated response that is selectively determined by an automated application based upon the particular characteristics of the captured image. Put in simple terms, computers do not excel in distinguishing between the target image or segmented image needed by the particular application, and the other objects or entities in the ambient image that constitute “clutter” for the purposes of the application requiring the target image. This problem is particularly pronounced when the shape of the target image is complex (such as the use of a single fixed sensor to capture images of a human being free to move in three-dimensional space). For example, mere changes in angle can result in dramatic differences with regards to the apparent shape of the target.

Conventional segmentation technologies typically take one of two approaches. One category of approaches (“edge/contour approaches”) focuses on detecting the edge or contour of the target object to identify motion. A second category of approaches (“region-based approaches”) attempts to distinguish various regions of the ambient image to identify the segmented image. The goal of these approaches is neither to divide the segmented image into smaller regions (“over-segment the target”) nor to include what is background into the segmented image (“under-segment the target”). Without additional contextual information, which is what helps a human being make such accurate distinctions, the effectiveness of both region-based approaches and edge/contour based approaches are limited. The effectiveness of such solutions in the context of segmenting images of human beings from an ambient image that includes the area surrounding the human being can be particularly disappointing. The wide range of human clothing, including solid, striped, and oddly patterned clothing can add to the difficulty in segmenting an image that includes a human being as the target image.

It would be desirable if the segmentation system were to purposely under-segment the target image from the ambient image, identifying a “region-of-interest” within the ambient image. It would be desirable for such a “region-of-interest” to be identified by comparing the ambient image with a reference image (“template image”) captured in the same environment as the ambient image. Such purposeful under-segmentation can then be followed up with additional segmentation processing, if desired. The art known to the Applicants fails to disclose or even suggest such features for a segmentation system. The very concept that enhanced segmentation can occur by purposely attempting to under-segment the target from the ambient image is counterintuitive. However, the end result of such a process can be very useful.

### SUMMARY OF THE INVENTION

The present invention relates in general to a system or method (collectively “segmentation system” or simply the “system”) for segmenting images. More specifically, the present invention relates to a system for identifying a region-of-interest within a captured image (the “ambient image”). The ambient image includes a target image (the “segmented image” of the target) as well as the area surrounding the target.

The segmentation system can invoke a de-correlation process to identify a tentative region-of-interest within the ambient image. A watershed process can then performed to definitively identify the region-of-interest within the ambient image. In some embodiments, subsequent segmentation processing is performed to fully isolate the segmented image of the target within the region-of-interest image.

In some vehicle safety restraint embodiments, the region-of-interest image or the segmented image obtained from the region-of-interest is used to determine a classification of the occupant (e.g. the target), as well as determine the position and motion characteristics of the occupant in the vehicle.

In some embodiments, the process of identifying a region-of-interest can include pixel-based operations, patch-based operations, and region-based operations.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a process flow diagram illustrating an example of a process beginning with the capture of an ambient image from an image source or “target” and ending with the identification of a segmented image from within the ambient image.

FIG. 2 is a hierarchy diagram illustrating an example of a image hierarchy including an image made up of various regions, with each region made up of various patches, and with each patch made up of various pixels.

FIG. 3 is a hierarchy diagram illustrating an example the relationship between patch-level, region-level, image-level and application-level processing.

FIG. 4 is an environmental diagram illustrating an example of an operating environment for an intelligent automated safety restraint application incorporating the segmentation system.

FIG. 5 is a process flow diagram illustrating an example of the processing that can be performed by an intelligent automated safety restraint application incorporating the segmentation system.

FIG. 6a is a block diagram illustrating a subsystem-level view of the segmentation system.

FIG. 6b is a block diagram illustrating a subsystem-level view of the segmentation system.

FIG. 7 is a flow chart illustrating an example of a region-of-interest heuristic for segmenting images.

FIG. 8 is a flow chart illustrating an example of a region-of-interest heuristic for segmenting images.

FIG. 9a is a diagram illustrating an example of an “exterior lighting” template image in a segmentation system.

FIG. 9b is a diagram illustrating an example of an “interior lighting” template image in a segmentation system.

FIG. 9c is a diagram illustrating an example of a “darkness” template image in a segmentation system,

FIG. 10 is a process-flow diagram illustrating an example of a de-correlation heuristic that includes the use of a template image.

FIG. 11a is a diagram illustrating an example of an incoming ambient image that can be processed by a segmentation system.

FIG. 11b is a diagram illustrating an example of a template or reference image that can be used by a segmentation system.

FIG. 11c is a diagram illustrating an example of a gradient ambient image that can be generated by a segmentation system.

FIG. 11d is a diagram illustrating an example of a gradient template image that can be used by a segmentation system.

FIG. 11e is a diagram illustrating an example of a resultant de-correlation map generated by a segmentation system

FIG. 11f is a diagram illustrating an example of an image extracted using the de-correlation map generated by a segmentation system.

FIG. 12 is a process flow diagram illustrating an example of a watershed heuristic.

FIG. 13a is a diagram illustrating an example of a contour image generated by the segmentation system.

FIG. 13b is a diagram illustrating an example of a marker image generated by a segmentation system.

FIG. 13c is a diagram illustrating an example an interim segmented image generated by a segmentation system.

FIG. 13d is a diagram illustrating an example of a partially segmented image to be subjected to a watershed heuristic by a segmentation system.

FIG. 13e is a diagram illustrating an example of an updated marker image generated by a segmentation system.

FIG. 13f is a diagram illustrating an example of region-of-interest identified by a segmentation system.

### DETAILED DESCRIPTION

The present invention relates in general to a system or method (collectively the “segmentation system” or simply the “system”) for identifying an image of a target (the “segmented image” or “target image”) from within an image the includes the target and the surrounding area (collectively the “ambient image”). More specifically, the system identifies a region-of-interest image from within the ambient image that can then be used as either a proxy for the segmented image, or subjected to subsequent processing to further identify the segmented image from within the region-of-interest image.

I. Introduction of Elements

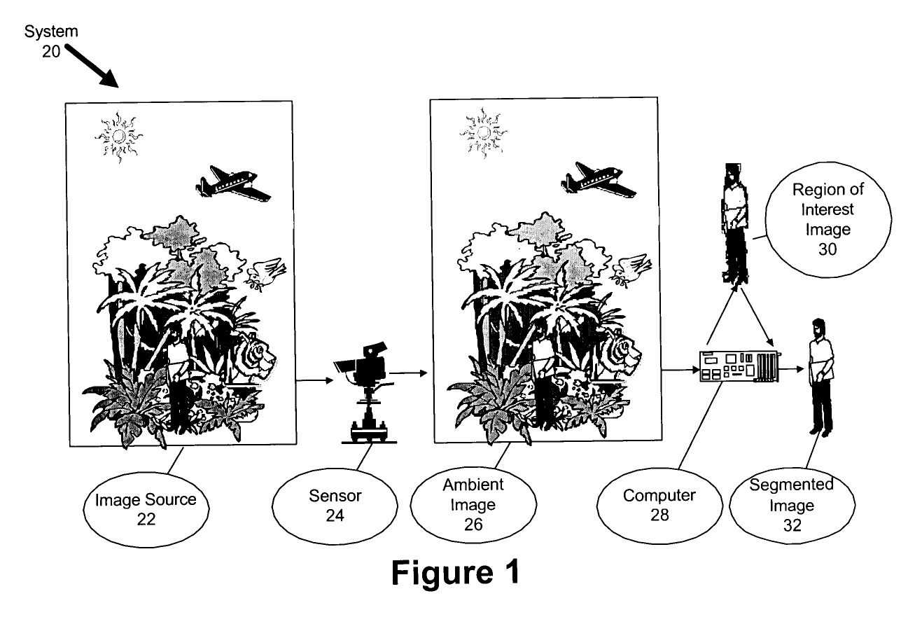

FIG. 1 is a process flow diagram illustrating an example of a process performed by a segmentation system (the “system”) 20 beginning with the capture of an ambient image 26 from an image source 22 with a sensor 24 and ending with the identification of a segmented image 32.

A. Image Source

The image source 22 is potentially any individual or combination of persons, organisms, objects, spatial areas, or phenomena from which information can be obtained. The image source 22 can itself be an image or some other form of representation. The contents of the image source 22 need not physically exist. For example, the contents of the image source 22 could be computer-generated special effects. In an embodiment of the system 20 that involves an intelligent safety restraint application (a “safety restraint application” such as an airbag deployment application) used in a vehicle, the image source 22 is the occupant of the vehicle and the area in the vehicle surrounding the occupant. Unnecessary deployments, as well as potentially inappropriate failures to deploy, can be avoided by providing the safety restraint application with information about the occupant obtained from one or mores sensors 24.

In other embodiments of the system 20, the image source 22 may be a human being (various security embodiments), persons and objects outside of a vehicle (various external vehicle sensor embodiments), air or water in a particular area (various environmental detection embodiments), or some other type of image source 22.

The system 20 can capture information about an image source 22 that is not light-based or image-based. For example, an ultrasound sensor can capture information about an image source 22 that is not based on “light” characteristics.

B. Sensor

The sensor 24 is any device capable of capturing the ambient image 26 from the image source 22. The ambient image 26 can be at virtually any wavelength of light or other form of medium capable of being either (a) captured in the form of an image, or (b) converted into the form of an image (such as a ultrasound “image”). The different types of sensors 24 can vary widely in different embodiments of the system 20. In a vehicle safety restraint application embodiment, the sensor 24 may be a standard or high-speed video camera. In a preferred embodiment, the sensor 24 should be capable of capturing images fairly rapidly, because the various heuristics used by the system 20 can evaluate the differences between the various sequence or series of images to assist in the segmentation process. In some embodiments of the system 20, multiple sensors 24 can be used to capture different aspects of the same image source 22. For example, in a safety restraint embodiment, one sensor 24 could be used to capture a side image while a second sensor 24 could be used to capture a front image, providing direct three-dimensional coverage of the occupant area. In other embodiments, image-processing can be used to obtain or infer three-dimensional information from a two-dimensional ambient image 26.

The variety of different types of sensors 24 can vary as widely as the different types of physical phenomenon and human sensation. Some sensors 24 are optical sensors, sensors 24 that capture optical images of light at various wavelengths, such as infrared light, ultraviolet light, x-rays, gamma rays, or light visible to the human eye (“visible light”), and other optical images. In many embodiments, the sensor 24 may be a video camera. In a preferred airbag deployment embodiment, the sensor 24 is a standard video camera.

Other types of sensors 24 focus on different types of information, such as sound (“noise sensors”), smell (“smell sensors”), touch (“touch sensors”), or taste (“taste sensors”). Sensors can also target the attributes of a wide variety of different physical phenomenon such as weight (“weight sensors”), voltage (“voltage sensors”), current (“current sensor”), and other physical phenomenon (collectively “phenomenon sensors”). Sensors 24 that are not image-based can still be used to generate an ambient image 26 of a particular phenomenon or situation.

C. Ambient Image

An ambient image 26 is any image captured by the sensor 24 from which the system 20 desires to identify a segmented image 32. Some of the types of characteristics of the ambient image 26 are determined by the characteristics of the sensor 24. For example, the markings in an ambient image 26 captured by an infrared camera will represent different target or source characteristics than the ambient image 26 captured by a ultrasound device. The sensor 24 need not be light-based in order to capture the ambient image 26, as is evidenced by the ultrasound example mentioned above.

In some preferred embodiments, the ambient image 26 is a digital image. In other embodiments it is an analog image that is converted to a digital image. The ambient image 26 can also vary in terms of color (black and white, grayscale, 8-color, 16-color, etc.) as well as in terms of the number of pixels and other image characteristics.

In a preferred embodiment of the system 20, a series or sequence of ambient images 26 are captured. The system 20 can be aided in image segmentation if different snapshots of the image source 22 are captured over time. For example, the various ambient images 26 captured by a video camera can be compared with each other to see if a particular portion of the ambient image 26 is animate or inanimate.

D. Computer System or Computer

In order for the system 20 to perform the various heuristics and processing (collectively “heuristics”) described below in a real time or substantially real-time manner, the system 20 can incorporate a wide variety of different computational devices, such as programmable logic devices (“PLDs”), embedded computers, desktop computers, laptop computers, mainframe computers, cell phones, personal digital assistants (“PDAs”), satellite pagers, various types and configurations of networks, or any other form of computation devices that is capable of performing the logic necessary for the functioning of the system 20 (collectively a “computer system” or simply a “computer” 28). In many embodiments, the same computer 28 used to segment the segmented image 32 from the ambient image 26 is also used to perform the application processing that uses the segmented image 32. For example, in a vehicle safety restraint embodiment such as an airbag deployment application, the computer 28 used to identify the segmented image 32 from the ambient image 26 can also be used to determine: (1) the kinetic energy of the human occupant needed to be absorbed by the airbag upon impact with the human occupant, (2) whether or not the human occupant will be too close (the “at-risk-zone”) to the deploying airbag at the time of deployment; (3) whether or not the movement of the occupant is consistent with a vehicle crash having occurred; and/or (4) the type of occupant, such as adult, child, rear-facing child seat, etc.

The computer 28 can include peripheral devices used to assist the computer 28 in performing its functions. Peripheral devices are typically located in the same geographic vicinity as the computer 28, but in some embodiments, may be located great distances away from the computer 28.

E. Segmented Image or Target Image

The output from the computer 28 used by the segmentation system 20 is in the form of a segmented image 30. It is the segmented image 30 that is used by various applications to obtain information about the “target” within the ambient image 22.

The segmented image 32 is any portion or portions of the ambient image 26 that represents a “target” for some form of subsequent processing. The segmented image 32 is the part of the ambient image 26 that is relevant to the purposes of the application using the system 20. Thus, the types of segmented images 32 identified by the system 20 will depend on the types of applications using the system 20 to segment images. In a vehicle safety restraint embodiment, the segmented image 32 is the image of the occupant, or at least the upper torso portion of the occupant. In other embodiments of the system 20, the segmented image 32 can be any area of importance in the ambient image 26.

The segmented image 32 can also be referred to as the “target image” because the segmented image 32 is the reason why the system 20 is being utilized by the particular application.

In some embodiments, the segmented image 32 is a region-of-interest image 30. In other embodiments, the segmented image 32 is created from the region-of-interest image 30.

F. Region-of-Interest Image

The process of identifying the segmented image 32 from within the ambient image 26 includes the process of identifying a region-of-interest image 30 from within the ambient image 26.

In some embodiments, the region-of-interest image 30 can be used as a proxy for the segmented image 32. For example, the region-of-interest image 30 can be useful in classifying the type of occupant in a safety restraint embodiment of the system 20. In other embodiments, the region-of-interest image 30 is subjected to subsequent segmentation processing to identify the segmented image 32 from within the region-of-interest image 30. In such embodiments, the region-of-interest image 32 can be thought of as an interim or “in process” segmented image 32.

The region-of-interest image 30 is a type of segmented image 32 where the system 20 purposely risks under-segmentation to ensure that portions of the ambient image 26 representing the target are not accidentally omitted. Thus, the region-of-interest 30 will typically include portions of the ambient image 26 that should not be attributed to the “target.”

II. Hierarchy of Image Elements

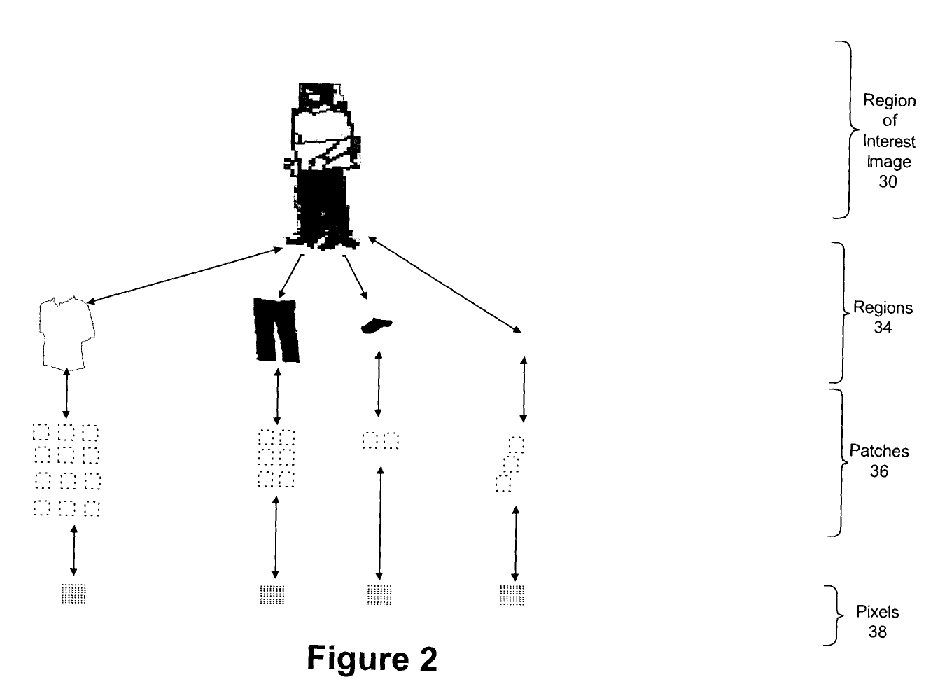

FIG. 2 is a hierarchy diagram illustrating an example of an element hierarchy that can be applied to the region-of-interest image 30, the segmented image 32, the ambient image 26, or any other image processed by the system 20.

A. Images

At the top of the image hierarchy is an image. For the purposes of the example in FIG. 2, the image is a region-of-interest image 30. However, the hierarchy can also apply to ambient images 26, segmented images 32, the various forms of “work in process” images that are discussed below, and any other type or form of image (collectively “image”).

Images are made up of one or more image regions 34.

B. Image Regions

Image regions or simply “regions” 34 can be identified based on shared pixel characteristics relevant to the purposes of the application invoking the system 20. Thus, regions 34 can be based on color, height, width, area, texture, luminosity, or potentially any other relevant characteristics. In embodiments involving a series of ambient images 26 and targets that move within the ambient image 26 environment, regions 34 are preferably based on constancy or consistency, as is described in greater detail below.

In some embodiments, regions can themselves be broken down into other regions 34 (“sub-regions”) based on characteristics relevant to the purposes of the application invoking the system 20 (the “invoking application”). Sub-regions can themselves be made up of even smaller sub-regions. Regions 34 and sub-regions are the lowest elements in the image hierarchy that are associated with image characteristics relevant to the purposes of the invoking application.

Ultimately, images and regions 34 can be broken down into some form of fundamental “atomic” unit. In many embodiments, this fundamental unit is referred to as pixels 38. However, it can be useful to perform processing based on neighborhoods of pixels 28 that can be referred to as patches 36.

C. Patches

A patch 36 is a grouping of adjacent pixels 36. The size and shape of the patch 36 can vary widely from embodiment to embodiment. In a preferred vehicle safety restraint embodiment, each patch 36 is made up a square of pixels 36 that are 8 pixels high and 8 pixels across. In a preferred embodiment, each patch 36 in the image is the same shape as all other patches 36, and each patch 36 is made up of the same number of pixels 38. In other embodiments, the shape and size of the patches 36 can vary within the same image. By grouping the various pixels 38 into patches 36, the system 20 can use the characteristics of neighboring pixels 38 to impact how the system 20 treats a particular pixel 38. Thus, patches 36 support the ability of the system 20 to perform bottom-up processing.

In some embodiments, patches 36 can overlap neighboring patches 36, and a single pixel 38 can belong to multiple patches 36 within a particular image. In other embodiments, patches 36 cannot overlap, and a single pixel 38 is associated with only one patch 36 within a particular image.

D. Pixels

A pixel 38 is an indivisible part of one or more patches 36 within the image. The number of pixels 38 within the image determines the limits of detail and information that can be included in the image. Pixel characteristics such as color, luminosity, constancy, etc. cannot be broken down into smaller units for the purposes of segmentation.

The number of pixels 38 in the ambient image 26 will be determined by the type of sensor 24 and sensor configuration used to capture the ambient image 26.

III. Hierarchy of Processing Levels

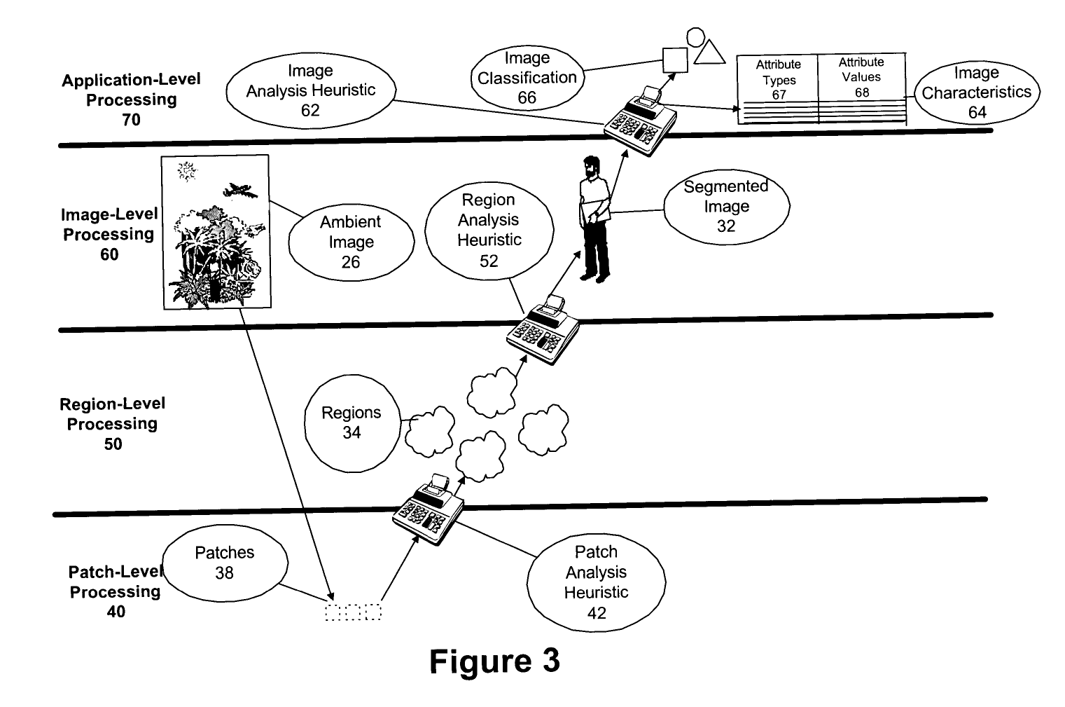

FIG. 3 is a process-level hierarchy diagram illustrating the different levels of processing that can be performed by the system 20. These processing levels typically correspond to the hierarchy of image elements discussed above and illustrated in FIG. 2. As disclosed in FIG. 3, the processing of the system 20 can include patch-level processing 40, region-level processing 50, image-level processing 60, and application-level processing 70. Each of these levels of processing can involve performing operations on individual pixels 36. For example, creating a gradient map as described below, is an example of a image-level process because it is performed on entire image as a whole. In contrast, generating a de-correlation map as described below, is a patch-level process because the process being performed is a done on a patch 36 by patch 36 basis.

There is typically a relationship between the level of processing and the sequence in which processing is performed. Different embodiments of the system 20 can incorporate different sequences of processing, and different relationships between process level and processing sequence. In a typical embodiment, image-level processing 60 and application-level processing 70 will typically be performed at the end of the processing of a particular ambient image 26.

In the example in FIG. 3, processing is performed starting at the left side of the diagram to the right side of the diagram. Thus, in the illustration, the system 20 begins with image-level processing 54 relating to the capture of the ambient image 26.

A. Initial Image-Level Processing

The initial processing of the system 20 relates to process steps performed immediately after the capture of the ambient image 26. In many embodiments, initial image-level processing includes the comparing of the ambient image 26 to one or template images. In a preferred embodiment, the template image is selected from a library of template images based on the particular environmental/lighting conditions of the ambient image 26. A gradient map heuristic, described in detail below, can be performed on the ambient image 26 and the template image to create gradient maps for both images. The gradient maps are then subject to patch-level processing 40.

B. Patch-Level Processing

Patch-level processing 40 includes processing that is performed on the basis of small neighborhoods of pixels 38 referred to as patches 36. Patch-level processing 40 includes the performance of a potentially wide variety of patch analysis heuristics 42. A wide variety of different patch analysis heuristics 42 can be incorporated into the system 20 to organize and categorize the various pixels 38 in the ambient image 26 into various regions 34 for region-level processing 50. Different embodiments may use different pixel characteristics or combinations of pixel characteristics to perform patch-level processing 40.

Some patch analysis heuristics 42 are described below. Such heuristics 42 can include generating a de-correlation map from the template gradient image and ambient template image, as described below.

C. Region-Level Processing

A wide variety of region analysis heuristics 52 can be used to determine which regions 34 belong in the region-of-interest image 30 and which regions 34 do not belong in the region-of-interest image 30. These processes are described in greater detail below.

The process of designating the largest initial region 34 after the performance of a de-correlation thresholding heuristic as the “target” within the ambient image 26 is an example of a region analysis heuristics 52.

Region analysis heuristics 52 ultimately identify the boundaries of the segmented image 32 within the ambient image 26. The segmented image 32 is used to perform subsequent image-level processing 60.

D. Subsequent Image-Level Processing

The segmented image 32 can then be processed by a wide variety of potential image analysis heuristics 62 to identify image classifications 66 and image characteristics 64 as part of application-level processing 56. Image-level processing typically marks the border between the system 20, and the application or applications invoking the system 20. The nature of the application should have an impact on the type of image characteristics 32 passed to the application. The system 20 need not have any cognizance of exactly what is being done during application-level processing 70.
1. Image Characteristics

The segmented image 32 is useful to applications interfacing with the system 20 because certain image characteristics 64 can be obtained from the segmented image 32. Image characteristics can include a wide variety of attribute types 67, such as color, height, width, luminosity, area, etc. and attribute values 68 that represent the particular trait of the segmented image 32 with respect to the particular attribute type 67. Examples of attribute values 68 can include blue, 20 pixels, 0.3 inches, etc. In addition to being derived from the segmented image 32, expectations with respect to image characteristics 64 can be used to help determine the proper scope of the segmented image 32 within the ambient image 26. This “boot strapping” approach is way of applying some application-related context to the segmentation process implemented by the system 20.

Image characteristics 64 can include statistical data relating to an image or a even a sequence of images. For example, the image characteristic 64 of image constancy can be used to assist in the process of whether a particular portion of the ambient image 26 should be included as part of the segmented image 32.

In a vehicle safety restraint embodiment of the system 20, the segmented image 32 of the vehicle occupant can include characteristics such as relative location with respect to an at-risk-zone within the vehicle, the location and shape of the upper torso, and/or a classification as to the type of occupant.
2. Image Classification

In addition to various image characteristics 64, the segmented image 32 can also be categorized as belonging to one or more image classifications 66. For example, in a vehicle safety restraint application, the segmented image 32 could be classified as an adult, a child, a rear facing child seat, etc. in order to determine whether an airbag should be precluded from deployment on the basis of the type of occupant. In addition to being derived from the segmented image 32, expectations with respect to image classification 38 can be used to help determine the proper boundaries of the segmented image 32 within the ambient image 26. This “boot strapping” process is a way of applying some application-related context to the segmentation process implemented by the system 20. Image classifications 66 can be generated in a probability-weighted fashion. The process of selectively combining image regions into the segmented image 32 can make distinctions based on those probability values.

E. Application-Level Processing

In an embodiment of the system 20 invoked by a vehicle safety restraint application, image characteristics 64 and image classifications 66 can be used to preclude airbag deployments when it would not be desirable for those deployments to occur, invoke deployment of an airbag when it would be desirable for the deployment to occur, and to modify the deployment of the airbag when it would be desirable for the airbag to deploy, but in a modified fashion.

In other embodiments of the system 20, application-level processing 70 can include any response or omission by an automated system 20 to the image classification 66 and/or image characteristics 64 provided to the application.

IV. Environmenal View of a Vehicle Safety Restraint Embodiment

A. Partial Environmental View

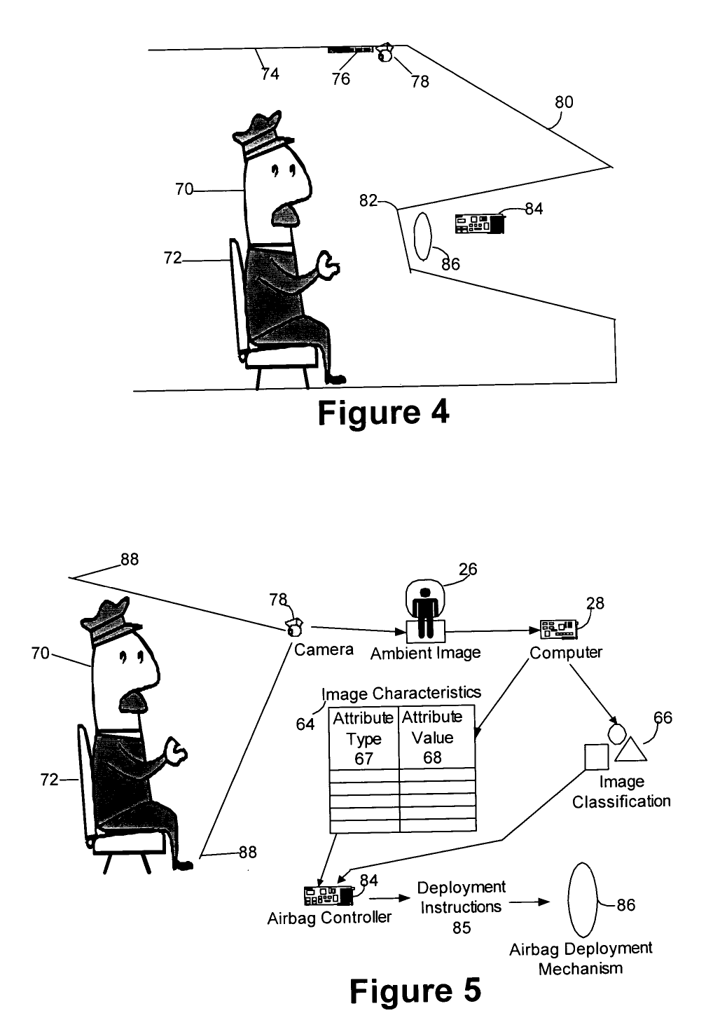

FIG. 4 is a partial view of the surrounding environment for potentially many different vehicle safety restrain embodiments of the segmentation system 20. If an occupant 70 is present, the occupant 70 can sit on a seat 72. In some embodiments, a video camera or any other sensor capable of rapidly capturing images (collectively “camera” 78) can be attached in a roof liner 74, above the occupant 70 and closer to a front windshield 80 than the occupant 70. The camera 78 can be placed in a slightly downward angle towards the occupant 70 in order to capture changes in the angle of the occupant's 70 upper torso resulting from forward or backward movement in the seat 72. There are many potential locations for a camera 78 that are well known in the art. Moreover, a wide range of different cameras 78 can be used by safety restraint applications, such as airbag deployment mechanisms. In a preferred embodiment, a standard video camera that typically captures approximately 40 images per second is used by the system 20. Higher and lower speed cameras 78 can be used in alternative embodiments.

In some embodiments, the camera 78 can incorporate or include an infrared or other light sources operating on direct current to provide constant illumination in dark settings. The safety restraint application can be designed for use in dark conditions such as night time, fog, heavy rain, significant clouds, solar eclipses, and any other environment darker than typical daylight conditions. The safety restraint application can also be used in brighter light conditions. Use of infrared lighting can hide the use of the light source from the occupant 70. Alternative embodiments may utilize one or more of the following: light sources separate from the camera; light sources emitting light other than infrared light; and light emitted only in a periodic manner utilizing alternating current. The vehicle safety restrain application can incorporate a wide range of other lighting and camera 78 configurations. Moreover, different heuristics and threshold values can be applied by the safety restrain application depending on the lighting conditions. The safety restraint application can thus apply “intelligence” relating to the current environment of the occupant 70.

A computational device 76 capable of running a computer program needed for the functionality of the vehicle safety application may also be located in the roof liner 74 of the vehicle. In a preferred embodiment, the computational device 76 is the computer 28 used by the segmentation system 20. The computational device 76 can be located virtually anywhere in or on a vehicle, but it is preferably located near the camera 78 to avoid sending camera images through long wires.

A safety restraint controller 84, such as an airbag controller, is shown in an instrument panel 82. However, the safety restraint application could still function even if the safety restraint controller 84 were located in a different environment. In an airbag deployment mechanism of the safety restraint application, an airbag deployment mechanism 86 is also preferably located within the instrument panel 82.

Similarly, an airbag deployment mechanism 86 is preferably located in the instrument panel 82 in front of the occupant 70 and the seat 72. Alternative embodiments may include side airbags coming from the door, floor, or elsewhere in the vehicle. In some embodiments, the controller 84 is the same device as the computer 28 and the computational device 76. In other embodiments, two of the three devices may be the same component, while in still other embodiments, all three components are distinct from each other. The vehicle safety restraint application can be flexibly implemented to incorporate future changes in the design of vehicles and safety restraint mechanisms.

Before the airbag deployment mechanism or other safety restrain application is made available to consumers, the computational device 76 can be loaded with preferably predetermined classes 66 of occupants 70 by the designers of the safety restraint deployment mechanism. The computational device 76 can also be preferably loaded with a list of predetermined attribute types 67 useful in distinguishing the preferably predetermined classes 66. Actual human and other test “occupants” or at the very least, actual images of human and other test “occupants” may be broken down into various lists of attribute types 67 that make up the pool of potential attribute types 67. Such attribute types 67 may be selected from a pool of features or attribute types 67 include features such as height, brightness, mass (calculated from volume), distance to the airbag deployment mechanism, the location of the upper torso, the location of the head, and other potentially relevant attribute types 44. Those attribute types 44 could be tested with respect to the particular predefined classes 66, selectively removing highly correlated attribute types 67 and attribute types 67 with highly redundant statistical distributions. Only desirable and useful attribute types 67 and classifications 66 should be loaded into the computational device 76.

B. Process Flow for the Deployment of the Safety Restraint

FIG. 5 discloses a process flow diagram illustrating one example of the segmentation system 20 being used by a safety restraint application.

An ambient image 26 of a seat area 88 that includes both the occupant 70 and surrounding seat area 88 can be captured by the camera 78. In the figure, the seat area 88 includes the entire occupant 70, although under many different circumstances and embodiments, only a portion of the occupant's 70 image will be captured, particularly if the camera 78 is positioned in a location where the lower extremities may not be viewable.

The ambient image 26 can be sent to the computer 28 described above. The computer 28 obtains the region-of-interest image 30. That image is ultimately used as the segmented image 32, or it is used to generate the segmented image 32. The segmented image 32 is then used to identify one or more relevant image classifications 66 and/or image characteristics 64 of the occupant. As discussed above, image characteristics 64 include attribute types 67 and their corresponding attribute values 68. Image characteristics 64 and/or image classifications 66 can then be sent to the safety restraint controller 84, such as an airbag controller, so that deployment instructions 85 can be generated and transmitted to a safety restraint deployment mechanism such as the airbag deployment mechanism 86. The deployment instructions 85 should instruct the deployment mechanism 86 to preclude deployment of the safety restraint in situations where deployment would be undesirable due to the classification 66 or characteristics 64 of the occupant. In some embodiments, the deployment instructions 85 may include a modification instruction, such as an instruction to deploy the safety restraint at only half strength.

V. Subsystem-Level View

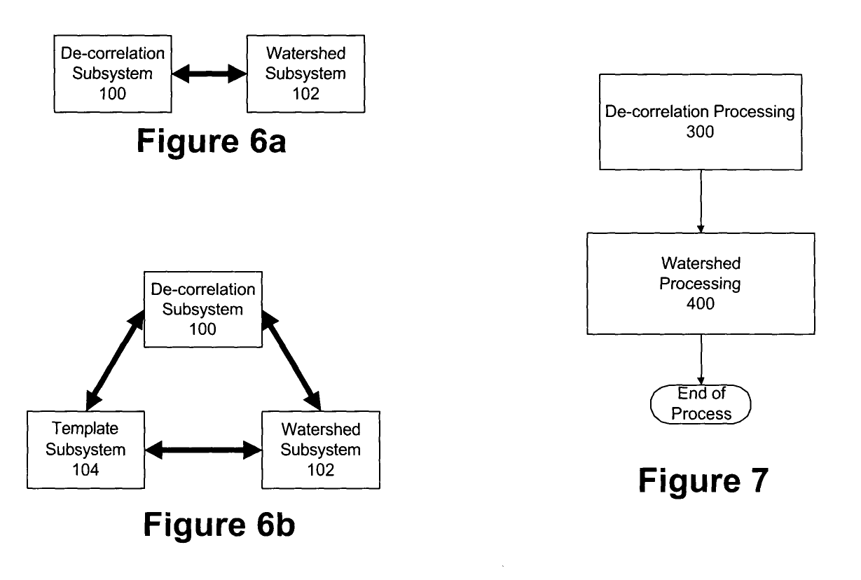

FIG. 6a is block diagram illustrating an example of a subsystem-level view of the system 20.

A. De-Correlation Subsystem

A de-correlation subsystem 100 can be used to perform a de-correlation heuristic. The de-correlation heuristic identifies an initial target image by comparing the ambient image 26 with a template image of the same spatial area that does not include a target.

In preferred embodiments, the two images being compared are gradient images created from the ambient image 26 and template image. In some embodiments, the template image used by the de-correlation subsystem 100 is selectively identified from a library of potential template images on the basis of the environmental conditions, such as lighting. A corresponding template gradient image can also be created from a template image devoid of any “target” with the spatial area. The de-correlation subsystem 100 can then compare the two gradient images and identify an initial or interim segmented image 30 through various de-correlation heuristics. The various gradient images and de-correlation images of the de-correlation subsystem 100 can be referred to as gradient maps and de-correlation maps, respectively. The de-correlation subsystem 100 can also perform a thresholding heuristic using a cumulative distribution function of the de-correlation map.

Some examples of processing performed by the de-correlation subsystem 100 are described in greater detail below.

B. Watershed Subsystem

A watershed subsystem 102 can invoke a watershed heuristic on the initial segmented image 32 or the initial region-of-interest image 30 generated by the de-correlation subsystem 100. The watershed heuristic can include preparing a contour map of markers to distinguish between pixels 38 representing the region-of-interest image 30 and pixels 38 representing the area surrounding the target. The contour map can also be referred to as a marker map. A “water flood” process is performed until the boundaries of the markers fill all unmarked space.

The watershed subsystem 102 provides for the creation of a marker with a contour or boundary, from the interim image generated by the de-correlation subsystem. The watershed subsystem 102 can then perform various iterations of updating the markers and expanding the marker boundaries or contours in accordance with the “water flood” heuristic. When all of the pixels fall under a marker boundary, the process is completed, the region-of-interest image 30 is identified in accordance with the last iteration of markers and contours.

Some examples of the watershed heuristics that can be performed by the watershed subsystem 102 are described in greater detail below.

C. Template Subsystem

As indicated above, the system 20 can utilize various template images in performing various steps of the various region-of-interest heuristics. FIG. 6b is a block diagram illustrating a subsystem-level view of the system 20 that includes a template subsystem 104.

In a preferred embodiment, there is more than one template image for a particular spatial area memorialized in the ambient image 26. In one category of embodiments, a template subsystem 104 is used to support a library of template images. The template image corresponding to the conditions in which the sensor 24 captured the ambient image 26 can be identified and selected for use by the system 20. For example, a different template image of the interior of a vehicle can be used depending on lighting conditions.

Some of the various template images that can be supported by the template subsystem 104 are described in greater detail below.

VI. Process-Level Views

A. One Embodiment of a Region-of-Interest Heuristic

FIG. 7 is a flow chart illustrating an example of a category of region-of-interest heuristics that can be performed by the system 20 to generate a region-of-interest image 30 from the ambient image 26. There are a wide variety of region-of-interest heuristics that can be incorporated into the system 20.

At 300, a de-correlation heuristic or process is performed to identify a preliminary or interim region-of-interest image 30 within the ambient image 26. At 400, a watershed processing heuristic is performed to define the boundary of the region-of-interest image 30 using the interim image generated by the de-correlation heuristic.

B. A Second Embodiment of a Region-of-Interest Heuristic

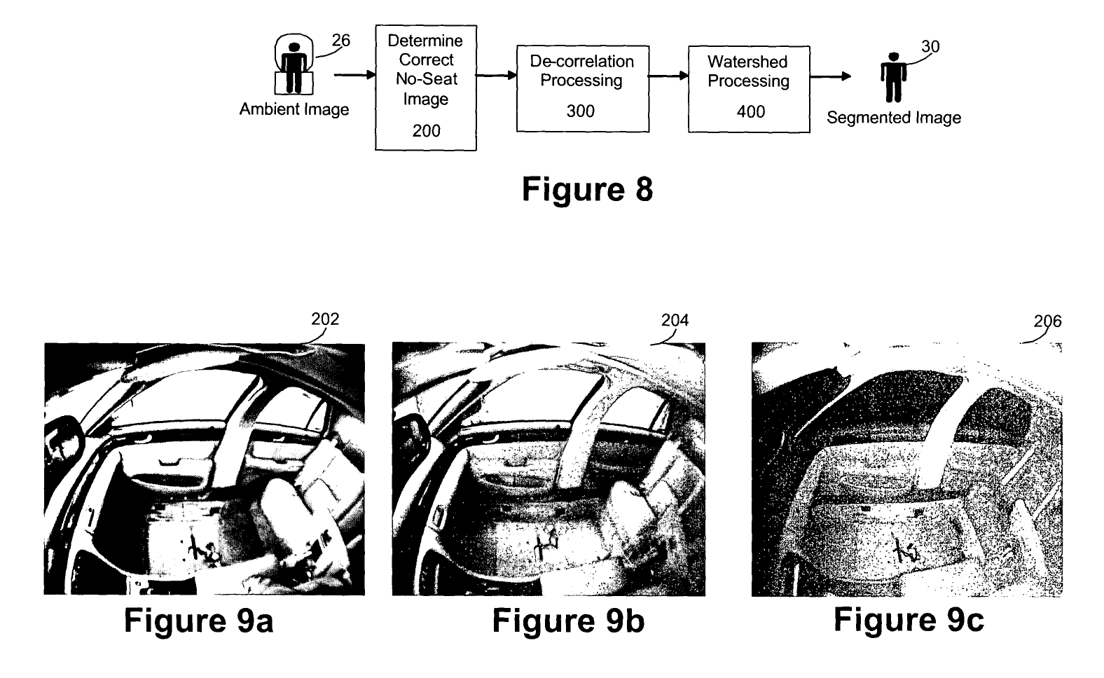

FIG. 8 is a flow chart illustrating a second category of region-of-interest heuristics. The ambient image 26 is used at 200 to determine the correct template image, which can be referred to as a no-occupant image in a vehicle safety restraint embodiment of the system 20.
1. Selection of Template Image

Image segmentation is a very fundamental problem in computer vision. Background subtraction is a method typically used to pull out the difference regions between current image and static background image. In a preferred vehicle safety restraint embodiment of the system 20, the camera 78 is somehow fixed within the vehicle, and thus the system 20 should be able to separate the occupant 70 from the background pixels 38 within the ambient image 26. In a preferred vehicle safety restraint embodiment, the template image is obtained by capturing an image of the spatial area with the car seat removed and by applying a background-subtraction-like de-correlation processing heuristic.

Due to real-time requirements and limited memory resources, only three background or template images are preferably used in a vehicle safety restraint embodiment of the system 20. Those three template images are collected outdoors, indoors and at night, respectively. Finding the correct no-seat image or template image can be important to attain good segmentation based on the de-correlation processing performed by the de-correlation subsystem 100. Three no-seat images with different lighting levels are prepared as background images for the algorithm to choose from as shown in FIGS. 9a, 9b, 9c.

FIG. 9a is a diagram illustrating an example of an “exterior lighting” template image 202 in a segmentation system 20. FIG. 9b is a diagram illustrating an example of an “interior lighting” template image 204 in a segmentation system. FIG. 9c is a diagram illustrating an example of a “darkness” template image 206 in a segmentation system,

The selection of the appropriate template image is performed in accordance with a template image selection heuristic. The system 20 can include a wide variety of different template image selection heuristics. Some template image selection heuristics may attempt to correlate the appropriate image based on image characteristics 64 such as luminosity. In a preferred embodiment, the template image selection heuristic attempts to match a predefined portion of each template image to the corresponding location (“test region”) within in the ambient image 26. For example, the front, top, and left hand corner of the ambient image 26 could be used because the occupant 70 is unlikely to be in those areas of the ambient image 26.

With regards to a comparison of the test regions in each template image, the system 20 can get three values from three equations corresponding to the three template images. Mc, Mo, Mi and Mn are the matrixes that consist of all pixels 38 in the test region of: (a) the current ambient image 26 (Mc); (b) the outdoor no-seat template image (Mo); (c) the indoor no-seat template image (Mi); and (d) the night no-seat template image (Mn),
Σ|Mc−Mo|=selection metric Equation 1:
Σ|Mc−Mi|=selection metric Equation 2:
Σ|Mc−Mn|=selection metric Equation 3:

The correct template image can be determined by looking for the minimal value among the three selection metric values.

The system 20 can incorporate a wide variety of different template selection heuristics, but such heuristics are not mandatory for the system 20 to function.
2. De-Correlation Heuristic

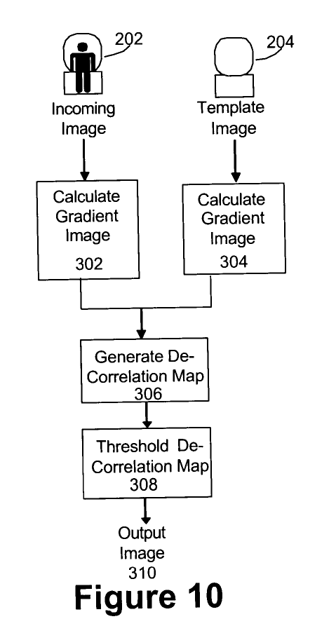

Returning to FIG. 8, de-correlation processing can be performed at 300 after the appropriate template image is selectively identified. FIG. 10 is a process-flow diagram illustrating an example of a de-correlation heuristic that includes the use of a template image. FIG. 10 discloses a calculate gradient maps heuristic at 302 and 304, a generate de-correlation map heuristic at 306, and a threshold de-correlation map heuristic at 308.
a. Calculate Gradient Maps Heuristic

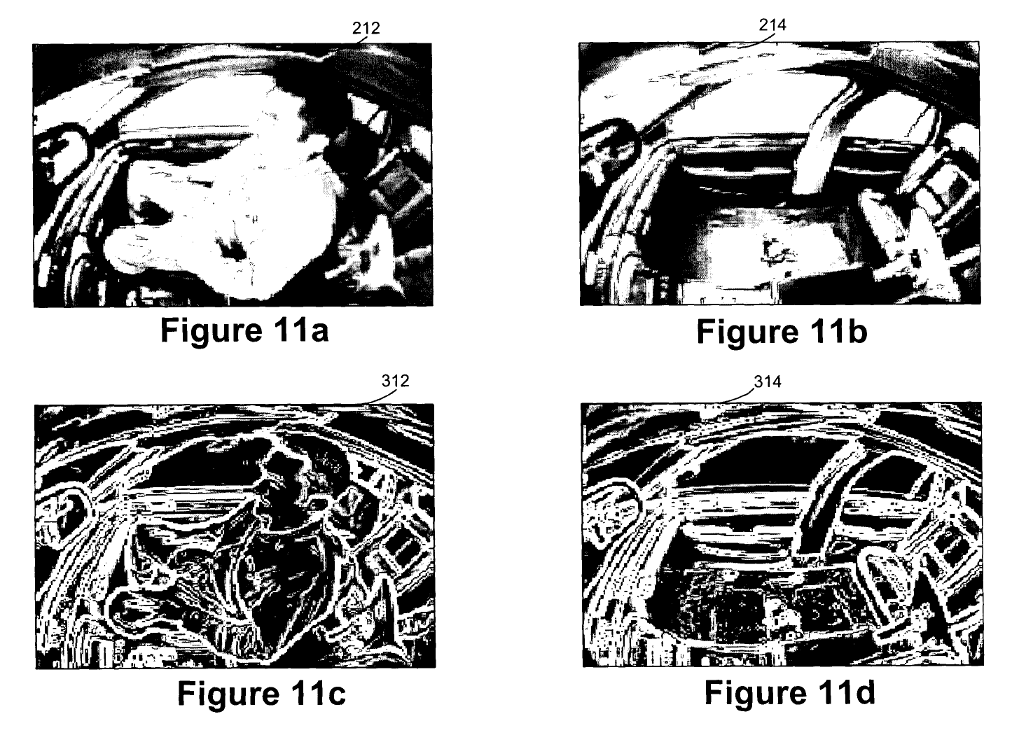

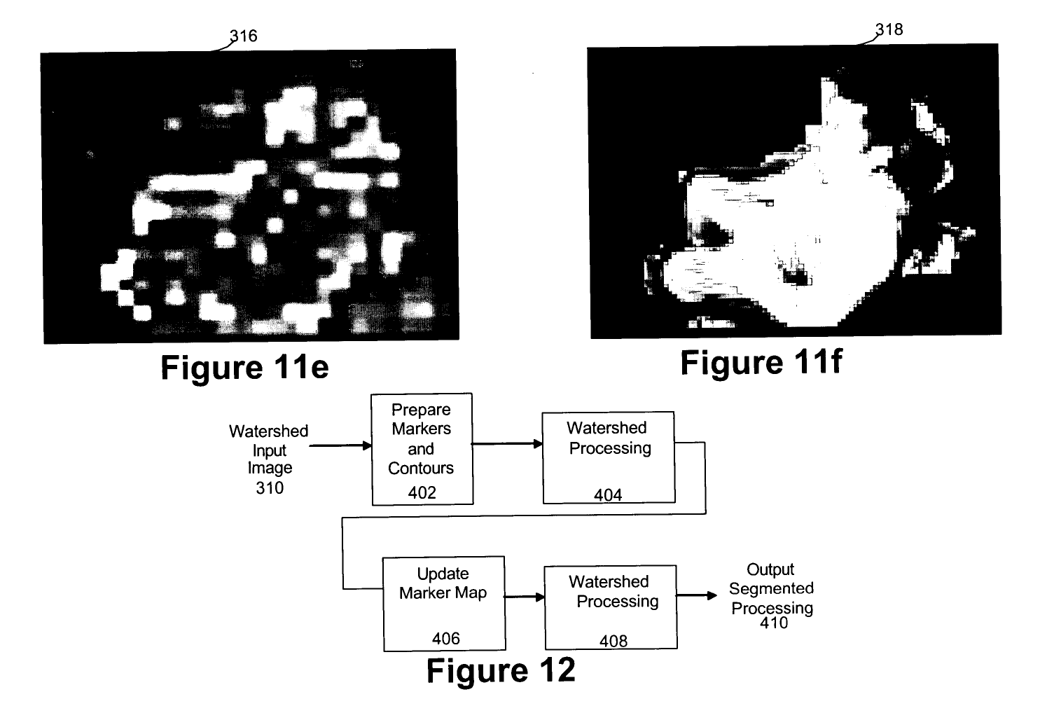

To alleviate the impact of lighting variations on image segmentation, a pre-processing step, calculating gradient maps of current and background images (g1(x,y) and g2(x,y)) as shown in FIGS. 11a-11d, is employed prior to de-correlation computing. The particular examples use a two-dimensional coordinate system, and thus “x” indicates a value for an x-coordinate and “y” indicates a value for a y coordinate 1. Some embodiments of the system 20 will not include a gradient maps heuristic because this step is not required for the proper functioning of the system 20.

FIG. 11a is a diagram illustrating an example of an incoming ambient image 212 that can be processed by a segmentation system 20. FIG. 11b is a diagram illustrating an example of a template or reference image 214 that can be used by a segmentation system 20 and corresponds to the spatial area in FIG. 11a. FIG. 11c is a diagram illustrating an example of a gradient ambient image 312 that is generated from the incoming image 212 in FIG. 11a. FIG. 11d is a diagram illustrating an example of a gradient template image 314 that is generated from the template image 214 of FIG. 11b for the purpose of comparison against the gradient image 312 in FIG. 11c.
b. Generate De-Correlation Map Heuristic

Returning to FIG. 10, the current image, whether it is the raw ambient image 26 or some other form of image that has been subjected to some type of pre-processing as discussed above, is divided into patches 36 of pixel neighborhoods. In a preferred image size of 160 pixels×200 pixels, the preferred patch size is 8 pixels×8 pixels. For each patch A on the current image, a small patch B at the same location on the template image is located by placing patch A on the top of background image and a correlation coefficient (C) is then computed in accordance with Equation 4:

$$C = \frac{{\sum }_{A} {\sum }_{B} g1 ( x , y ) \cdot g2 ( x , y )}{\sqrt{{\sum }_{A} {g1 ( x , y )}^{2} \cdot {\sum }_{B} {g2 ( x , y )}^{2}}}$$

This correlation coefficient serves as a similarity measure between the corresponding patches. Pixel values g1 and g2 are the luminosity values associated with the various x-y locations with the various patches 36. The current image and the background image are captured under very different illumination conditions, and thus the edges on both images are often seen to have a couple of pixels shift. To get an accurate closeness measure, a group of correlation coefficients is calculated similarly by placing patch A to other locations on the top of background image surrounding patch B. The maximum one in this group is then taken as an indicator of how close the current image and the background image are in the location of patch A. This value is then converted to the De-correlation coefficient (D) by D=1−C. All the pixels in the De-correlation map within patch A are assigned this D. Once the system 20 has the De-correlation map calculated, the system 20 can then low-pass filter this image to reduce speckles due to patch-wise processing.
c. Generate Threshold De-Correlation Map Heuristic

Adaptive thresholding can then be performed at 308. Adaptive thresholding should be designed to separate the foreground (occupant+car seat) and the background (car interior). The threshold is computed by using the Cumulative Distribution Function (CDF) of the De-correlation map and then determining the 50% value of the CDF. All the pixels in the De-correlation map calculated above at 306 with values greater than the 50% threshold value are kept as potential foreground pixels. Through the front window on the passage side, outside objects are usually seen in the image. These objects appear as noises in the image. These noises can be eliminated if the bottom edge of the front window is detected. Finally, the system 20 can pull out the largest region out of all candidate regions as the initial or interim segmented image and/or the initial or interim region-of-interest image.

FIG. 11e is a diagram illustrating an example of a resultant de-correlation map 316 generated by a segmentation system 20. FIG. 11f is a diagram illustrating an example of an image 318 extracted using the de-correlation map 316 of FIG. 11e generated by a segmentation system 20.
3. Watershed Heuristic

Returning to FIG. 8, one or more watershed heuristics can be invoked at 400 after the completion of the de-correlation heuristic. There are still some undesired regions extracted out as the foreground in the initial or interim image generated by the de-correlation heuristic. Watershed processing further cleans up these “noises.” Note all subsequent processing is carried out in the reduced region-of-interest (ROI) where the pixel values in the initial segment are non-zeros. FIG. 12 is a process flow diagram illustrating an example of a watershed heuristic. As illustrated in FIG. 12, watershed processing is preferably composed of four steps.

At 310, an input image is received for the watershed heuristic. In a preferred embodiment, the input image at 310 is an image that has been subject to adaptive tresholding at 308. The subsequent steps can include a prepare markers and contours heuristic at 402, an initial watershed processing heuristic at 404, an update marker map heuristic at 406, and a subsequent watershed processing heuristic at 408. Processing from 404 through 408 is a loop that can be repeated several times.
a. Prepare Markers and Contours Heuristic

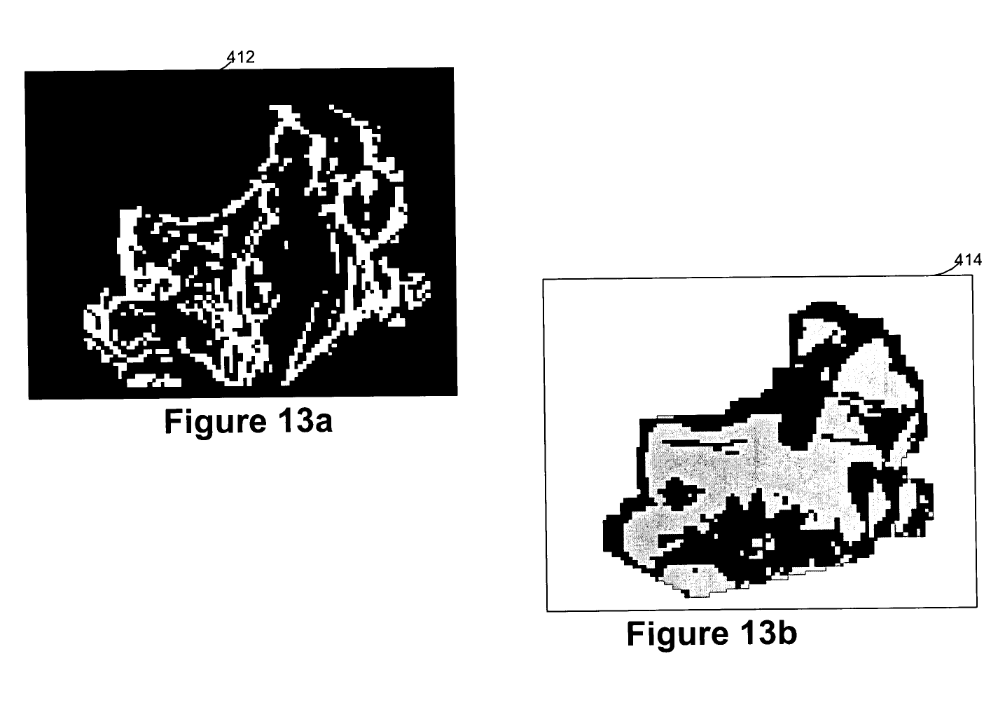

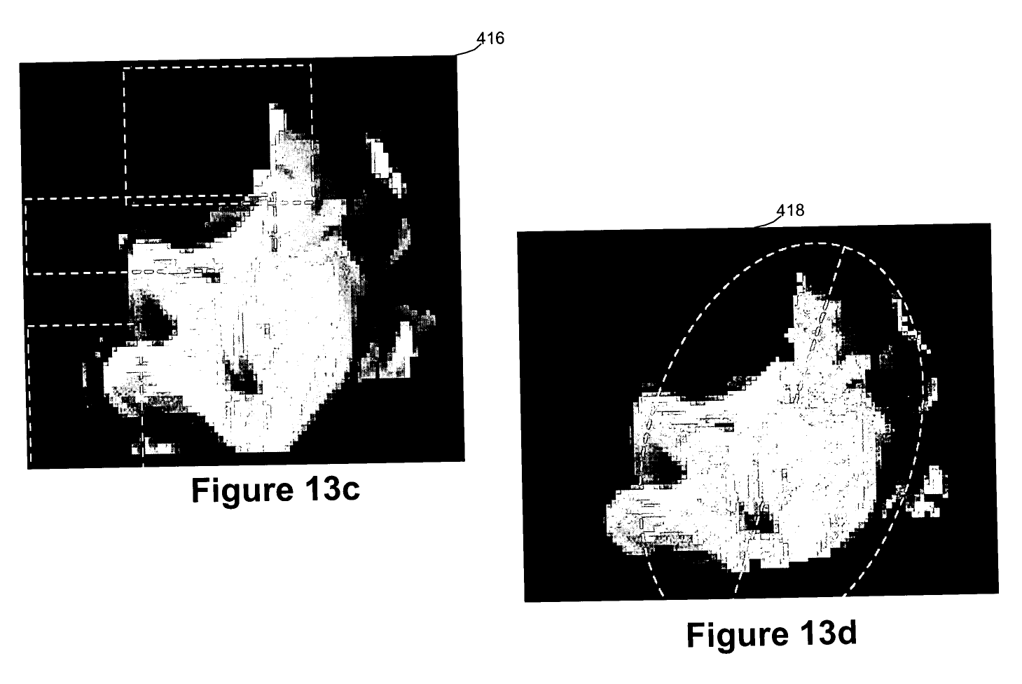

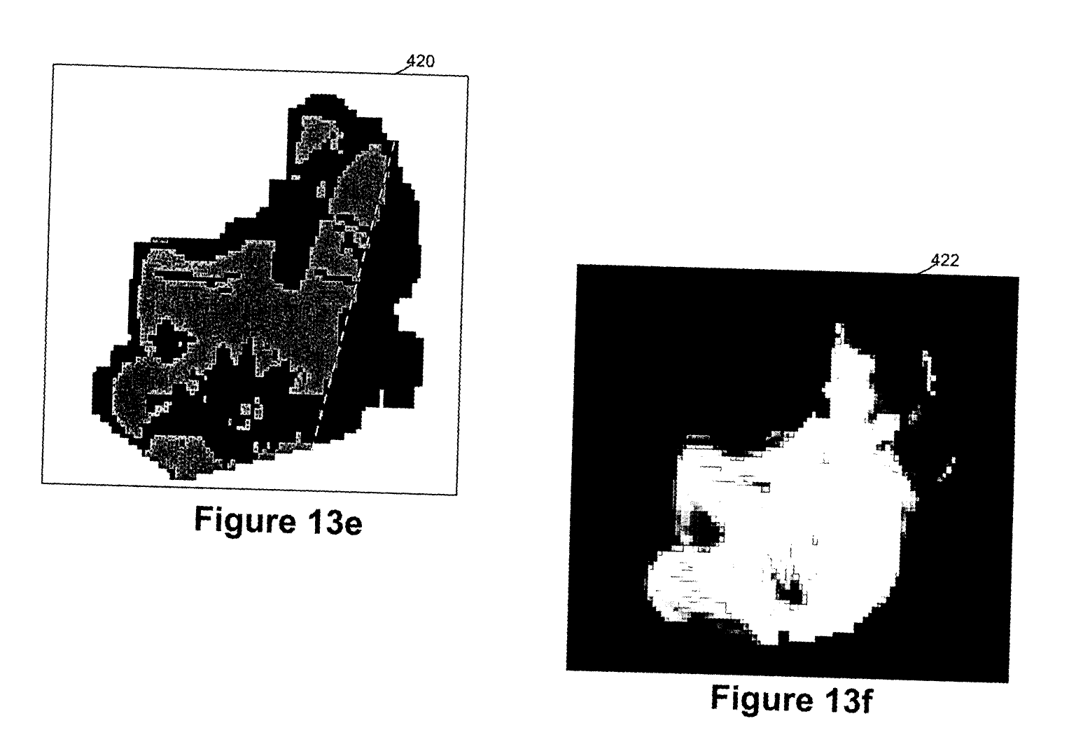

The marker map is preferably created in the following way. All the pixels 38 outside the current interim region-of-interest is set to a value of 2 and will be treated as markers for car interior. The markers associated with the foreground are set to a value of 1 by adaptively thresholding the difference image between the current and background image. The contour map is generated by thresholding the gradient map of the current image. Further updating contour and marker can be desired if there are excessive foreground points in certain regions, as shown the boxed areas in FIGS. 13a-13c. These certain regions are determined based on the prior knowledge of car interior.

FIG. 13a is a diagram illustrating an example of a contour image 412 generated by the segmentation system 20. FIG. 13b is a diagram illustrating an example of a marker image 414 generated by the segmentation system 20. FIG. 13c is a diagram illustrating an example an interim segmented image 416 generated by a segmentation system 20 upon the invoking of the initial watershed processing heuristic at 404.
b. Initial Watershed Processing Heuristic

The water flood starts from the markers and keeps propagating in a loop until it hits the boundaries defined by the contour map. A new interim region of interest or segmented image is achieved by finding all the pixels 38 in the watershed output image equal to 1. The system 20 can then estimate ellipse parameters on this interim or revised segmented image to update the marker map in the next stage of the processing.
c. Update Marker Map Heuristic

The revised segmented image can include both the occupant 70 and part of seat back 72, the system 20 may further refine the revised segmented image by adaptively clean markers near the bottom-right end based on the ellipse parameters. As shown in FIGS. 13d, 13e, and 13f, all makers beyond the red line are set to 0. This red line is parallel to the major axis of the ellipse, and about ⅔ of the minor axis away from the centroid. This new marker is used in the second run of watershed processing.

FIG. 13d is a diagram illustrating an example of a partially segmented image 418 to be subjected to a watershed heuristic by a segmentation system 20. FIG. 13e is a diagram illustrating an example of an updated marker image 420 generated by a segmentation system 20. FIG. 13f is a diagram illustrating an example of region-of-interest 422 identified by a segmentation system 20.
d. Subsequent Watershed Processing Heuristic

The water flood can start from the new set of markers and keeps propagation until it hits additional boundaries defined by the contour map. The final segmentation is achieved by finding all the pixels in the watershed output image equal to 1. FIG. 13f indicates an improvement of the interim segmented image illustrated in FIG. 13d.

VII. Applications Incorporated by Reference

This application incorporates by reference the contents of the following patent applications in their entirety: “A RULES-BASED OCCUPANT CLASSIFICATION SYSTEM FOR AIRBAG DEPLOYMENT,” Ser. No. 09/870,151, filed on May 30, 2001; “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” Ser. No. 09/901,805, filed on Jul. 10, 2001; “IMAGE PROCESSING SYSTEM FOR ESTIMATING THE ENERGY TRANSFER OF AN OCCUPANT INTO AN AIRBAG,” Ser. No. 10/006,564, filed on Nov. 5, 2001; “IMAGE SEGMENTATION SYSTEM AND METHOD,” Ser. No. 10/023,787, filed on Dec. 17, 2001; “IMAGE PROCESSING SYSTEM FOR DETERMINING WHEN AN AIRBAG SHOULD BE DEPLOYED,” Ser. No. 10/052,152, filed on Jan. 17, 2002; “MOTION-BASED IMAGE SEGMENTOR FOR OCCUPANT TRACKING,” Ser. No. 10/269,237, filed on Oct. 11, 2002; “OCCUPANT LABELING FOR AIRBAG-RELATED APPLICATIONS,” Ser. No. 10/269,308, filed on Oct. 11, 2002; “MOTION-BASED IMAGE SEGMENTOR FOR OCCUPANT TRACKING USING A HAUSDORF-DISTANCE HEURISTIC,” Ser. No. 10/269,357, filed on Oct. 11, 2002; “SYSTEM OR METHOD FOR SELECTING CLASSIFIER ATTRIBUTE TYPES,” Ser. No. 10/375,946, filed on Feb. 28, 2003; “SYSTEM OR METHOD FOR SEGMENTING IMAGES,” Ser. No. 10/619,035, filed on Jul. 14, 2003; and “SYSTEM OR METHOD FOR CLASSIFYING IMAGES,” Ser. No. 10/625,208, filed on Jul. 23, 2003.

VIII. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. A method for identifying a region-of-interest in an ambient image, comprising:
establishing a template image;
performing a de-correlation heuristic on the ambient image and the template image to obtain an initial segmented image;
invoking a watershed heuristic on the initial segmented image; and
generating a revised segmented image after invoking the watershed heuristic.

2. The method of claim 1, wherein the revised segmented image is purposefully under-segmented.

3. The method of claim 1, wherein the revised segmented image is used by an airbag deployment application to make a deployment decision.

4. The method of claim 1, further comprising:
selecting the template image from a plurality of template images; and
comparing the selected template image and the ambient image.

5. The method of claim 4, wherein the plurality of template images relate to different light conditions.

6. The method of claim 1, wherein performing the de-correlation heuristic includes creating a plurality of maps for obtaining the initial segmented image.

7. The method of claim 6, wherein the plurality of maps includes at least two of a gradient map, a de-correlation map, and a threshold map.

8. The method of claim 1, wherein invoking the watershed heuristic includes preparing a marker.

9. The method of claim 1, wherein invoking the watershed heuristic includes preparing a contour.

10. The method of claim 1, wherein invoking the watershed heuristic includes updating a marker map.

11. The method of claim 1, further comprising performing a subsequent segmentation heuristic on the revised segmented image and generating a final segmented image.

12. A image segmentation system, comprising:
a de-correlation subsystem, said de-correlation subsystem providing for a gradient map, a de-correlation map, a threshold map, an input image, and an interim image;
wherein said de-correlation subsystem provides for the creation of said gradient map from said input image;
wherein said de-correlation subsystem is configured to generate a de-correlation map from said gradient map;
wherein said de-correlation subsystem is configured to calculate a threshold map from said de-correlation map;
wherein said de-correlation subsystem selectively identifies said interim image from said threshold map;
a watershed subsystem, said watershed subsystem providing for a marker, a contour, a marker map, and a region-of-interest image;
wherein said watershed subsystem provides for the creation of said marker and said contour from said interim image;
wherein said watershed subsystem is configured to update said marker map with said marker and said contour; and
wherein said watershed subsystem selectively identifies said region-of-interest image with said marker map.

13. The system of claim 12, wherein said region-of-interest image is used to generate an airbag deployment decision.

14. The system of claim 13, wherein the deployment decision is based on an occupant classification and an occupant motion characteristic.

15. The system of claim 12, further comprising a template subsystem, said template subsystem providing for a plurality of template images, wherein said template subsystem is adapted to selectively identify a template image from said plurality of template images; and
wherein said de-correlation subsystem is adapted to create said interim image with said template image.

16. The system of claim 15, wherein each template image in said plurality of template images relate to a lighting condition.

17. The system of claim 15, wherein each template image in said plurality of template images is an image without a target.

18. The system of claim 12, wherein said threshold map is calculated from a cumulative distribution function.

19. The system of claim 12, wherein a correlation coefficient is calculated to create said de-correlation map.

20. The system of claim 12, wherein said region-of-interest image is purposely under-segmented.

21. An automated vehicle safety restraint system, comprising:
a sensor, said sensor providing for the capture of an ambient image;
an airbag deployment mechanism, said airbag deployment mechanism configured for the receipt of a deployment decision; and
a computer, said computer providing for the receipt of said ambient image and the identification of a region-of-interest image from said ambient image, and wherein said computer is configured to create said deployment decision using said region-of-interest image.

22. The system of claim 21, wherein said sensor is a standard video camera.

23. The system of claim 21, wherein said computer is configured to identify a segmented image within said region-of-interest image, and wherein said computer is configured to create said deployment decision from said segmented image.

24. The system of claim 21, wherein said deployment decision is made from an occupant classification and an occupant motion characteristic.
